(19) United States
(12) Patent Application Publication
(10) Pub. No.: US 2025/0077186 A1
(43) Pub. Date: Mar. 6, 2025

(54) METHOD AND DEVICE FOR GENERATING RANDOM NUMBER

(71) Applicant: BOE TECHNOLOGY GROUP CO., LTD., Beijing (CN)

(72) Inventors: ZHIDONG WANG, Beijing (CN); YOUXIANG XIA, Beijing (CN); HONGBO FENG, Beijing (CN); QUANGUO ZHOU, Beijing (CN); MENG GUO, Beijing (CN); JIUYANG CHENG, Beijing (CN)

(73) Assignee: BOE TECHNOLOGY GROUP CO., LTD., Beijing (CN)

(21) Appl. No.: 18/709,850

(22) PCT Filed: Aug. 29, 2023
(86) PCT No.: PCT/CN2023/115423

§ 371 Date: May 14, 2024

(51) Int. Cl. G06F 7/58

(52) U.S. Cl. CPC G06F 7/588

(57) ABSTRACT

Embodiments of the present disclosure relate to a method for generating a random number comprising: receiving a random number generation instruction; extracting physical information of a picture displayed on a display screen; generating a random number matrix based on the physical information; and generating a random number based on the random number matrix. Embodiments of the present disclosure also relate to a device for generating a random number.

### CROSS REFERENCE TO RELATED APPLICATIONS

This patent application is a National Stage Entry of PCT/CN2023/115423 filed on Aug. 29, 2023, the disclosure of which is incorporated by reference herein in its entirety as part of the present application.

### FIELD

The present disclosure relates to a method and device for generating a random number.

### BACKGROUND

Smart devices have now penetrated into all aspects of people's life, bringing great convenience to people's life and work. But at the same time, it also brings great threat to the user's data, privacy and even property security.

At present, a core of the security application service to the user is the cryptographic technology, and a random number serves as a root of trust of the cryptographic technology, and its generation method is the guarantee of the whole security application service.

### BRIEF DESCRIPTION

Embodiments of the present disclosure provide a method and device for generating a random number.

In an aspect of the present disclosure, there is provided a method for generating a random number including: receiving a random number generation instruction; extracting physical information of a picture displayed on a display screen; generating a random number matrix based on the physical information; and generating a random number based on the random number matrix. In one or more embodiments, the physical information of the displayed picture includes one or more of grayscale, brightness, voltage, or color attribute of a pixel of the displayed picture.

In one or more embodiments involving the method, extracting physical information of a picture displayed on a display screen includes: extracting the physical information of the picture being displayed on the display screen when the random number generation instruction is received.

In one or more embodiments involving the method, extracting physical information of a picture displayed on a display screen includes: detecting whether dwell time of the picture displayed on the display screen when the random number generation instruction is received is longer than a predetermined time threshold; and in response to a detection that the dwell time of the displayed picture is longer than the predetermined time threshold, extracting physical information of another picture displayed prior to the picture currently being displayed on the display screen, wherein the dwell time of the another picture on the display screen is no longer than the predetermined time threshold; or in response to a detection that the dwell time of the displayed picture is no longer than the predetermined time threshold, extracting the physical information of the picture currently being displayed on the display screen.

In one or more embodiments involving the method, the predetermined time threshold is longer than 1 minute.

In one or more embodiments involving the method, extracting physical information of a picture displayed on a display screen includes: detecting whether the display screen is in a random number operating interface when the random number generation instruction is received; and in response to a detection that the display screen is in the random number operating interface, extracting physical information of a picture displayed in a last frame of a non-random number operating interface before the display screen is switched to the random number operating interface, or in response to a detection that the display screen is in a non-random number operating interface, extracting the physical information of the picture currently being displayed on the display screen.

In one or more embodiments involving the method, the display screen includes m×n pixels arranged in an array, where m and n are positive integers. Generating a random number matrix based on the physical information includes: determining matrix elements of the random number matrix based on the physical information of the m×n pixels.

In one or more embodiments involving the method, the random number matrix includes an m×n matrix. The matrix elements of the m×n matrix are determined based on the physical information of the m×n pixels.

In one or more embodiments involving the method, the method further includes: determining whether the random number matrix is a square-order matrix, and, in response to a determination that the random number matrix is not a square-order matrix, creating the square-order matrix by performing matrix element cropping or matrix element addition to the m×n matrix formed from the physical information of the m×n pixels.

In one or more embodiments involving the method, in the case where m>n, matrix elements are cropped from the m×n matrix by removing m-n rows of matrix elements from the m×n matrix, to form an n×n square-order matrix, or matrix elements are added to the m×n matrix by inserting m-n columns of matrix elements into the m×n matrix, to form an m×m square-order matrix. A value of each inserted matrix element is calculated based on values of known matrix elements in a row where the inserted matrix element is located. In the case where m<n, matrix elements are cropped from the m×n matrix by removing n-m columns of matrix elements from the m×n matrix, to form an m×m square-order matrix, or matrix elements are added to the m×n matrix by inserting n-m rows of matrix elements into the m×n matrix, to form an n×n square-order matrix. The value of each inserted matrix element is calculated based on values of known matrix elements in the column where the inserted matrix element is located.

In one or more embodiments involving the method, in the case where m>n, matrix elements of the n+1st to mth rows of the m×n matrix are removed to form the n×n square-order matrix, or matrix elements of the n+1st to mth columns are inserted into the m×n matrix to form the m×m square-order matrix. In the latter case, the value of each inserted matrix element is calculated in one of the following ways:
an average of all known elements in the row where the inserted matrix element is located,
a root mean square of all known elements in the row where the inserted matrix element is located, or
a square root of a sum of squares of all known elements in the row where the inserted matrix element is located divided by the number of known elements in the row.

In the case where m<n, matrix elements of the m+1st to nth columns of the m×n matrix are removed to form the m×m square-order matrix, or matrix elements of the m+1st to nth rows are inserted into the m×n matrix to form the n×n square-order matrix. In the latter case, the value of each inserted matrix element is calculated in one of the following ways:
an average of all known elements in the column where the inserted matrix element is located.
a root mean square of all known elements in the column where the inserted matrix element is located, or
a square root of a sum of squares of all known elements in the column where the inserted matrix element is located divided by the number of known elements in the row.

In one or more embodiments involving the method, generating a random number based on the random number matrix includes: calculating an eigenvalue of the random number matrix based on the matrix elements of the random number matrix; performing a rounding operation on the calculated eigenvalue; determining whether a digit number of the rounded eigenvalue is an odd number or an even number; and, in response to a determination that the digit number of the rounded eigenvalue is an even number, selecting an even number of digits between the leftmost digit and the rightmost digit of the rounded eigenvalue as the random number; or in response to a determination that the digit number of the rounded eigenvalue is an odd number, selecting an odd number of digits between the leftmost digit and the rightmost digit of the rounded eigenvalue as the random number.

In one or more embodiments involving the method, generating a random number based on the random number matrix further includes: determining whether the digit number of the rounded eigenvalue is less than a predetermined digit number threshold; and in response to a determination that the digit number of the rounded eigenvalue is less than the predetermined digit number threshold: performing at least one secondary operation on the rounded eigenvalue until the digit number of the eigenvalue obtained after the secondary operation is not less than the predetermined digit number threshold, determining whether the digit number of the eigenvalue obtained after the secondary operation is an odd number or an even number, and in response to a determination that the digit number of the eigenvalue obtained after the secondary operation is an even number, selecting an even number of digits between the leftmost digit and the right most digit of the eigenvalue obtained after the secondary operation as the random number, or in response to a determination that the digit number of the eigenvalue obtained after the secondary operation is an odd number, selecting an odd number of digits between the leftmost digit and the rightmost digit the eigenvalue obtained after the secondary operation as the random number. The step of determining whether the digit number of the rounded eigenvalue is an odd number or an even number is performed in the case of the determination that the digit number of the rounded eigenvalue is not less than the predetermined digit number threshold.

In one or more embodiments involving the method, performing at least one secondary operation on the rounded eigenvalue includes performing at least one N-square operation or multiplier operation on the rounded eigenvalue, where N≥2.

In one or more embodiments involving the method, the eigenvalue of the random number matrix is calculated in one of the following ways:
determining a sum of all matrix elements of the random number matrix;
determining a sum of squares of all matrix elements of the random number matrix;
determining a square root of a sum of squares of all matrix elements of the random number matrix;
determining a sum of square roots of all matrix elements of the random number matrix; or determining a square of a sum of all matrix elements of the random number matrix.

In one or more embodiments involving the method, the random number matrix includes a square-order matrix, wherein the eigenvalue of the random number matrix is calculated in one of the following ways:
determining a sum of all matrix elements of the random number matrix;
determining a sum of squares of all matrix elements of the random number matrix;
determining a square root of a sum of squares of all matrix elements of the random number matrix;
determining a sum of square roots of all matrix elements of the random number matrix;
determining a square of a sum of all matrix elements of the random number matrix; or determining a trace or a norm of the square-order matrix.

In another aspect of the present disclosure, there is provided an apparatus for generating a random number, including: an instruction receiving component configured to receive a random number generation instruction; a physical information extraction component configured to extract physical information of a picture displayed on a display screen; a random number matrix generating component configured to generate a random number matrix based on the physical information; and a random number generation component configured to generate a random number based on the random number matrix. In one or more embodiments, the physical information of the displayed picture includes one or more of grayscale, brightness, voltage, or color attribute of a pixel of the displayed picture.

In an embodiment of the present disclosure involving the device, the physical information extraction component is configured to extract the physical information of the picture currently being displayed on the display screen when the random number generation instruction is received.

In an embodiment of the present disclosure involving the device, the display screen includes m×n pixels arranged in an array, wherein m and n are positive integers.

In an embodiment of the present disclosure involving the device, the random number matrix includes an m×n matrix, wherein matrix elements of the m×n matrix are determined based on the physical information of the m×n pixels.

In an embodiment of the present disclosure involving the device, the random number matrix includes a square-order matrix. The random matrix generation component is configured to create the square-order matrix by performing matrix element cropping or matrix element addition to the m×n matrix formed from the physical information of the m×n pixels.

In an embodiment of the present disclosure involving the device, the random number generation component is configured to:
calculate an eigenvalue of the random number matrix based on the matrix elements of the random number matrix; perform a rounding operation on the calculated eigenvalue; determine whether a digit number of the rounded eigenvalue is an odd number or an even number; and, in response to a determination that the digit number of the rounded eigenvalue is an even number, select an even number of digits between the leftmost digit and the rightmost digit of the rounded eigenvalue as the random number; or in response to a determination that the digit number of the rounded eigenvalue is an odd number, select an odd number of digits between the leftmost digit and the rightmost digit of the rounded eigenvalue as the random number.

In an embodiments of the present disclosure involving the device, the random number generation component is configured to calculate the eigenvalue of the random number matrix in one of the following ways:
determining a sum of all matrix elements of the random number matrix;
determining a sum of squares of all matrix elements of the random number matrix;
determining a square root of a sum of squares of all matrix elements of the random number matrix;
determining a sum of square roots of all matrix elements of the random number matrix; or
determining a square of a sum of all matrix elements of the random number matrix.

In an embodiment of the present disclosure involving the device, the random number matrix includes a square-order matrix. The random number generation component is configured to calculate the eigenvalue of the random number matrix in one of the following ways:
determining a sum of all matrix elements of the random number matrix;
determining a sum of squares of all matrix elements of the random number matrix;
determining a square root of a sum of squares of all matrix elements of the random number matrix;
determining a sum of square roots of all matrix elements of the random number matrix;
determining a square of a sum of all matrix elements of the random number matrix; or determining a trace or a norm of said square-order matrix.

In a further aspect of the present disclosure, there is provided another device for generating a random number including: at least one processor; and at least one memory including computer program code, which, when executed by the at least one processor, causes the device to perform the method described in detail in any one of the embodiments of the present disclosure involving a method.

Further aspects and areas of applicability will become apparent from the description provided herein. It should be understood that various aspects of this application may be implemented individually or in combination with one or more other aspects. It should also be understood that the description and specific examples herein are intended for purposes of illustration only and are not intended to limit the scope of the present application.

### BRIEF DESCRIPTION OF THE DRAWINGS

The drawings described herein are for illustrative purposes only of selected embodiments and not all possible implementations, and are not intended to limit the scope of the present application. in the drawings:

FIG. 1 is a schematic diagram of the generation of a pseudo-random number;

FIG. 2 is a schematic diagram of the generation of a true random number;

FIG. 3 schematically illustrates a flowchart of a method for generating a random number in an embodiment of the present disclosure;

FIG. 4 schematically illustrates a pixel array of a display screen;

FIG. 5 schematically illustrates a flowchart of generating a random number based on a random number matrix in one or more embodiments of the present disclosure;

FIG. 6 schematically illustrates a flowchart of a method for generating a random number in another embodiment of the present disclosure;

FIG. 7 schematically illustrates a flowchart of a method for generating a random number in yet another embodiment of the present disclosure;

FIG. 8 schematically illustrates a flowchart of a method for generating a random number according to still another embodiment of the present disclosure;

FIG. 9A illustrates a schematic diagram of creating a square-order matrix by matrix element cropping in the case where m>n in some embodiments of the present disclosure;

FIG. 9B illustrates a schematic diagram of creating a square-order matrix by matrix element cropping in the case where men in some embodiments of the present disclosure;

FIG. 9C illustrates a schematic diagram of creating a square-order matrix by matrix element addition in the case where m>n in some embodiments of the present disclosure;

FIG. 9D illustrates a schematic diagram of creating a square-order matrix by matrix element addition in the case where men in some embodiments of the present disclosure;

FIG. 10 is a block diagram of a device for generating a random number in one or more embodiments of the present disclosure;

FIG. 11 is a block diagram of another device for generating a random number in one or more embodiments of the present disclosure; and

FIG. 12 is a schematic diagram of an apparatus for generating a random number in one or more embodiments of the present disclosure.

Corresponding reference numerals indicate corresponding parts or features throughout the several views of the drawings.

### DETAILED DESCRIPTION

Various embodiments, which are provided as exemplary examples of the present disclosure, will now be described in detail with reference to the accompanying drawings to enable those skilled in the art to implement the present disclosure. It should be noted that the following accompanying drawings and examples are not meant to limit the scope of the present disclosure. Where particular elements of the present disclosure may be partially or fully implemented using known components (or methods or processes), only those parts of such known components (or methods or processes) that are necessary for an understanding of the present disclosure will be described, and the detailed descriptions of other parts of such known components (or methods or processes) will be omitted so as not to confuse the present disclosure. Further, various embodiments encompass present and future known equivalents to the components (or methods or processes) referred to herein by way of illustration.

The flow diagrams depicted herein are just one example. There may be many variations to this diagram or the steps described therein without departing from the spirit of the disclosure. For instance, the steps may be performed in a differing order or steps may be added, deleted or modified. All of these variations are considered a part of the claimed disclosure.

As used herein, the expressions “have”, “comprise” and “contain” as well as grammatical variations thereof are used in a non-exclusive way. Thus, the expression “A has B” as well as the expression “A comprises B” or “A contains B” may both refer to the fact that, besides B, A contains one or more further components and/or constituents, and to the case in which, besides B, no other components, constituents or elements are present in A. The terms “a”, “an”, “the”, “said” and “at least one” are used to indicate the presence of one or more elements/components/etc.

There are two types of random numbers commonly used in related technologies, one is a pseudo-random number and the other is a true random number.

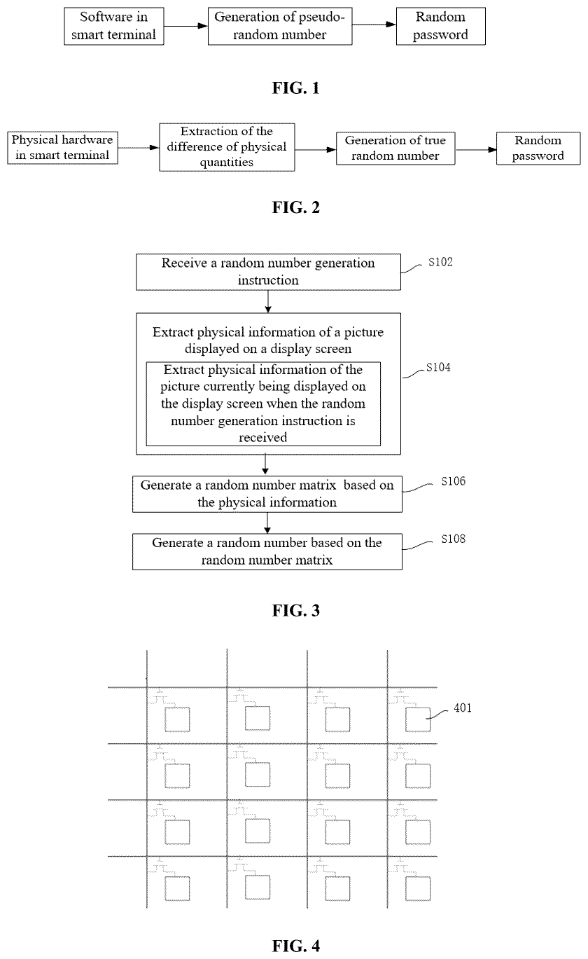

A pseudo-random number is usually generated using a software manner. Specifically, the pseudo-random number may be generated by a specific algorithm that generates a random sequence for verification of identity and the like. FIG. 1 is a schematic diagram of the generation of a pseudo-random number. As shown in FIG. 1, software in a smart terminal may generate a pseudo-random number by a specific algorithm, and then generate a random password based on the pseudo-random number. However, such pseudo-random number generated by the specific algorithm may be cracked through multiple attempts to find a regulation. Therefore, the security of such pseudo-random number is low.

A true random number is usually generated by utilizing the inherent and unclonable manifestation of physical characteristics of an object. For example, a true random number is generated by utilizing physical noise in nature, such as, device noise, nuclear decay noise, Brownian motion noise, thermal noise, and amplifying, extracting, and post-processing the physical noise in nature. FIG. 2 is a schematic diagram of the generation of a true random number. As shown in FIG. 2, a physical hardware on a smart terminal extracts the difference of physical quantities, generates a true random number based on the difference of physical quantities (physical unclonable (PUF)), and then generates a random password based on the true random number. The method of generating a true random number based on physical non-clonality has a high security level, but it has the disadvantage of high technical requirements. For example, it requires a high-precision measurement equipment and is severely affected by circuit processes, voltage and temperature.

Embodiments of the present disclosure provide a method and device for generating a random number that generate a random number array based on physical information displayed on a display screen, and then generates a random number based on the random number array. Since the picture displayed on a display screen of a smart device usually varies randomly, and the physical characteristics of individual pixels also vary randomly, the picture displayed on the display screen appears an obvious physical random phenomenon. The method of generating a random number based on a picture displayed on the display screen in embodiments of the present disclosure utilizes the physical random phenomenon, and therefore, the security is high. In addition, the generation of the random number described in embodiments of the present disclosure does not require additional high-precision measuring equipment, and thus the cost is less.

As used herein, a “display screen” may be a display screen of a smart terminal, such as a mobile terminal, a personal computer. The mobile terminal may be a hardware device having various operating systems such as a cellular phone, a tablet computer, a personal digital assistant, an e-book.

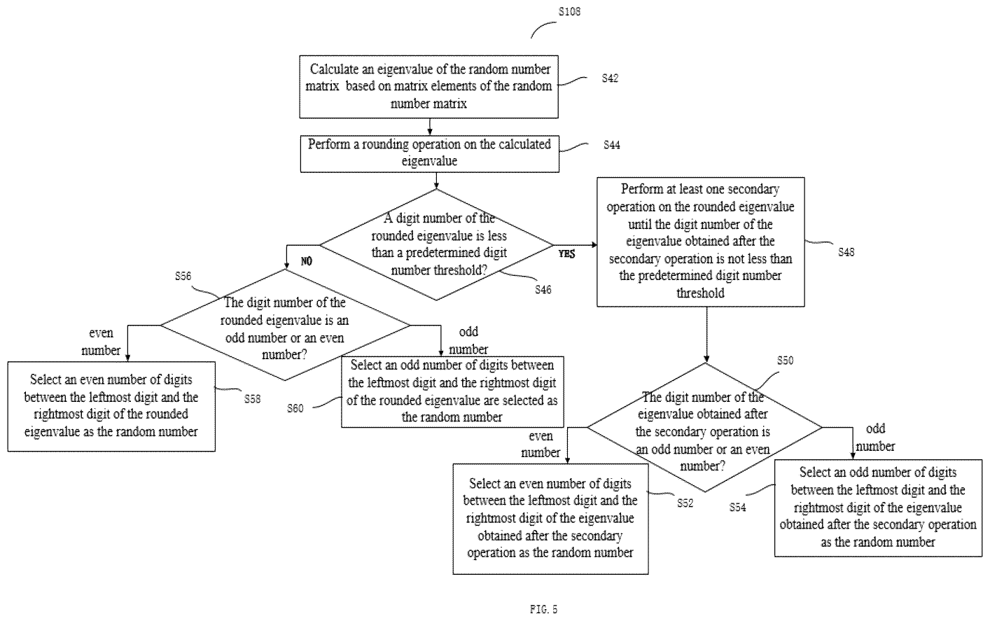

FIG. 3 schematically illustrates a flowchart of a method for generating a random number in an embodiment of the present disclosure. As shown in FIG. 3, the method for generating a random number may include the steps S102, S104, S106, and S108 as described in detail below. At step S102, a random number generation instruction is received.

In some exemplary embodiments of the present disclosure, the user may issue a random number generation instruction via an input/output interface of a smart terminal. The input/output interface may, for example, include a mouse, a keyboard, a touch screen, and the like. In some other embodiments, the random number generation instruction may be issued by a software on the smart terminal as needed.

At step S104, physical information of a picture displayed on a display screen is extracted.

In some embodiments, physical information of the picture currently being displayed on the display screen when the random number generation instruction is received may be extracted.

In some embodiments, the physical information of the displayed picture may include physical information of a pixel of the displayed picture. As an example, the physical information of the pixel may include a gray scale of the pixel. In alternative embodiments, the physical information of the pixel may also include brightness, voltage, or color attribute of the pixel.

Typically, the picture displayed on the display screen of the smart terminal changes rapidly, and the physical characteristics (e.g., gray scale, brightness, voltage, or color attribute) of each pixel also change randomly, and thus the extracted physical information of the picture currently being displayed on the display screen may have a great deal of randomness. As a result, the random number generated based on the extracted physical information also has better security.

The display screen may include a pixel array. FIG. 4 schematically illustrates a pixel array of a display screen. As shown in FIG. 4, the display screen may include m×n pixels 401 arranged in an array, wherein m and n are positive integers. By way of example, whenever the display screen displays a picture, light emitted from each pixel 401 has a specific brightness, which may also be represented by a gray scale representing a different brightness level from darkest to brightest. The more brightness levels there are, the finer the picture effect that may be rendered. An 8-bit display panel, for example, may have 28=256 gray scales. Usually, the picture displayed on the display screen may be updated frame by frame, and thus the gray scale of the corresponding pixel 401 of the picture will also change randomly frame by frame. Therefore, gray scale information of the pixels 401 of the picture currently displayed on the display screen may be extracted for use in generating a random number.

At step S106, a random number matrix is generated based on the extracted physical information.

As used herein, “random number matrix” may refer to a digital array generated from the physical information extracted from a picture displayed on a display screen, which digital array may be used to generate a random number.

In an exemplary embodiment, a random number matrix may be generated based on the gray scale information of the pixels 401 extracted in step S104. As an example, an m×n matrix may be generated to sever as the random number matrix. In this case, physical information (e.g., gray scales) of the m×n pixels 401 of the display screen may be determined as matrix elements of the m×n matrix. The generated random number matrix may be represented as:

$$( \begin{matrix}{a}_{11} & {a}_{12} & {a}_{13} & … & {a}_{mn} \\ {a}_{21} & {a}_{22} & {a}_{23} & … & {a}_{2 n} \\ {a}_{31} & {a}_{32} & {a}_{33} & … & {a}_{3 n} \\ ⋮ & ⋮ & ⋮ & ⋮ & ⋮ \\ {a}_{m 1} & {a}_{m 2} & {a}_{m 3} & … & {a}_{mn}\end{matrix} )$$

where aij is a matrix element represented by physical information (e.g., a gray scale) of a pixel, i and j are natural numbers, and 0≤aij≤255, 1≤i≤m, 1≤j≤n.

In some other embodiments, instead of constructing the physical information of all the pixels 401 of the display screen as matrix elements of the random number matrix, the physical information of a portion of the pixels 401 of the display screen may be constructed as matrix elements of the random number matrix. As an example, a rectangular region of the picture displayed on the display screen may be selected and the random number matrix may be created by using the physical information of the pixels 401 corresponding to the rectangular region. As another example, a set of discrete pixels 401 of the displayed picture may be randomly selected, and the random number matrix may be created by using the physical information of those selected discrete pixels 401. In the latter case, the randomness of the random matrix may be further improved, and thus the security of the random number may be increased.

At step S108, a random number is generated based on the random number matrix.

In this step, an eigenvalue of the random number matrix may be calculated based on the matrix elements of the random number matrix generated in step S107, and then the random number is obtained based on the eigenvalue.

FIG. 5 schematically illustrates a flowchart of generating a random number based on a random number matrix in one or more embodiments of the present disclosure. As shown in FIG. 5, generating a random number based on a random number matrix may include the steps S42, S44, S46, S48, S50, S52, S54, S56, S58, S60 as described in detail below.

At step S42, an eigenvalue of the random number matrix is calculated based on matrix elements of the random number matrix.

In this step, the eigenvalue of the random number matrix may be calculated in one of the following ways:
a) determining a sum of all matrix elements of the random number matrix, i.e., Σᵢ₌₁^{m}Σⱼ₌₁ⁿa(i,j);
b) determining a sum of squares of all matrix elements of the random number matrix, i.e., Σᵢ₌₁^{m}Σⱼ₌₁ⁿa²(i,j);
c) determining a square root of a sum of squares of all matrix elements of the random number matrix, i.e., \sqrt{Σᵢ₌₁^{m}Σⱼ₌₁ⁿa²(i,j)};
d) determining a sum of the square roots of all matrix elements of the random number matrix, i.e., Σᵢ₌₁^{m}Σⱼ₌₁ⁿ\sqrt{a(i,j)}; or
c) determining a square of a sum of all matrix elements of the matrix of random numbers, i.e., (Σᵢ₌₁^{m}Σⱼ₌₁ⁿa(i,j))².

At step S44, a rounding operation may be performed on the calculated eigenvalue. As described above, in the calculation of the eigenvalue, some operations (e.g., a square root operation) may cause the calculated eigenvalue to have a fractional part. In that case, a rounding operation may be performed on the calculated eigenvalue to remove the fractional part.

At step S46, optionally, it may be determined whether a digit number of the rounded eigenvalue is less than a predetermined digit number threshold. In the case where the digit number of the rounded eigenvalue is less than the predetermined digit number threshold, step S48 is performed, otherwise step S56 is performed.

In this step, the predetermined digit number threshold may be no less than 10.

In the case where the values of the matrix elements of the random number matrix are all small, the digit number of the calculated eigenvalue is small, so that the security of the generated random number is not high. In order to improve the security, a predetermined digit number threshold may be set.

At step S48, at least one secondary operation is performed on the rounded eigenvalue until the digit number of the eigenvalue obtained after the secondary operation is not less than the predetermined digit number threshold.

As an example, if the eigenvalue calculated in step S44 is 625876 and the digit number of the eigenvalue is 6, which is less than the predetermined digit number threshold, a secondary operation may be performed on the eigenvalue so that the digit number of the eigenvalue obtained after the secondary operation is not less than the predetermined digit number threshold.

The secondary operation may include an N-square operation or a multiplier operation on the rounded eigenvalue, wherein N is greater than or equal to 2. As an example, a square operation may be performed on the eigenvalue 625876, i.e., 625876×625876=391720767376. The digit number of the eigenvalue obtained after the square operation is greater than 10, and thus satisfies the requirement.

At step S50, it is determined whether the digit number of the eigenvalue obtained after the secondary operation is an odd number or an even number. In the case where the digit number of the eigenvalue obtained after the secondary operation is an even number, then step S52 is performed. In the case where the digit number of the eigenvalue obtained after the secondary operation is an odd number, step S54 is performed.

At step S52, an even number of digits between the leftmost digit and the rightmost digit of the eigenvalue obtained after the secondary operation is selected as the random number.

As an example, the above-mentioned eigenvalue 391720767376 obtained after the secondary operation has 12 digits, and thus the digit number is an even number. In this case, an even number of digits between the leftmost digit (i.e., 3) and the rightmost digit (i.e., 6) of 391720767376 may be selected as the random number. In this step, the digit number of the even number of digits selected as the random number may be determined based on the security requirement. By way of example, six digits between the leftmost digit (i.e., 3) and the rightmost digit (i.e., 6) of 391720767376 may be selected as the random number, that is, 720767 is selected as the random number.

At step S54, an odd number of digits between the leftmost digit and the rightmost digit of the eigenvalue obtained after the secondary operation is selected as the random number.

In this step, the digit number of the odd number of digits selected as the random number may be determined based on the security requirement.

At step S56, it is determined whether the digit number of the rounded eigenvalue is an odd number or an even number. In the case where the digit number of the rounded eigenvalue is an even number, step S58 is performed. In the case where the digit number of the rounded eigenvalue is an odd number, step S60 is performed.

At step S58, an even number of digits between the leftmost digit and the rightmost digit of the rounded eigenvalue is selected as the random number.

At step S60, an odd number of digits between the leftmost digit and the rightmost digit of the rounded eigenvalue are selected as the random number.

As described above, due to the randomness of the display screen displaying a picture, physical information of the picture currently being displayed on the display screen may be extracted, and the random number may be generated based on the physical information. The random number generated in such a manner is highly secure and does not require a high-precision measuring instrument, and thus the cost is low.

However, in the case where the picture displayed on the display screen has not been updated for a long time, for example, the user has not operated the display screen for a long time, the randomness of such a picture is relatively low. If the random number is generated by extracting the physical information of the picture currently being displayed on the display screen, the security may be relatively low. Therefore, in order to improve the randomness of the random number, it may be possible to detect whether dwell time of the displayed picture is longer than a predetermined time threshold.

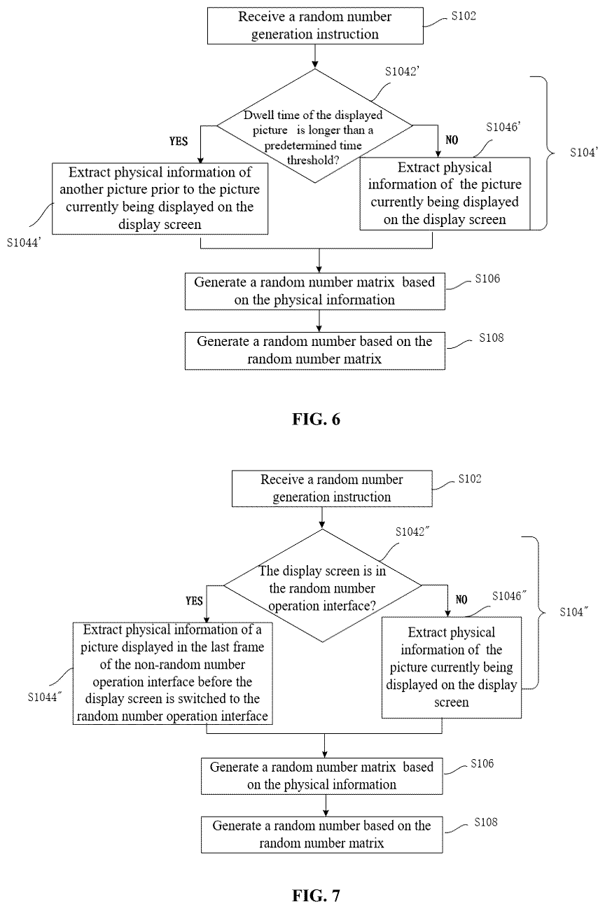

FIG. 6 schematically illustrates a flowchart of a method for generating random numbers in another embodiment of the present disclosure. The flowchart shown in FIG. 6 shares some similarities with the flowchart shown in FIG. 3, and the description provided with respect to FIG. 3 applies to the flowchart shown in FIG. 6 as appropriate.

As shown in FIG. 6, the method for generating a random number may include the steps S102, S104′, S106 and S108 as described in detail below. In the embodiment shown in FIG. 6, steps S102, S106, and S108 are the same as in the embodiment shown in FIG. 3, and thus the detailed description of steps S102, S106, and S108 in FIG. 3 applies equally to the flowchart shown in FIG. 6. Here, only the step S104′, i.e., the step of extracting the physical information of the picture displayed on the display screen, which is different from the embodiment shown in FIG. 3, is described in detail.

As shown in FIG. 6, extracting the physical information of the picture displayed on the display screen may include the sub-steps S1042′, S1044′ and S1046′ as described in detail below.

At sub-step S1042′, it is detected whether the dwell time of the picture displayed on the display screen when the random number generation instruction is received is longer than a predetermined time threshold. In the case where it is detected that the dwell time of the displayed picture is longer than the predetermined time threshold, sub-step S1044′ is performed. In the case where it is detected that the dwell time of the displayed picture is no longer than the predetermined time threshold, sub-step S1046′ is performed.

In an exemplary embodiment, the predetermined time threshold may be expressed in a frame number or time. As an example, the predetermined time threshold may be set to be not less than 1 minute.

At sub-step S1044′, physical information of another picture prior to the picture currently being displayed on the display screen is extracted. The dwell time of the another picture on the display screen is no longer than the predetermined time threshold.

In this sub-step, in the case where the dwell time of the picture currently being displayed on the display screen is longer than the predetermined time threshold, the dwell time of a previous picture of the picture currently being displayed on the display screen may be detected. When the dwell time of the previous picture on the display screen is still longer than the predetermined time threshold, the detection of the dwell time of the picture prior to that previous picture is continued until a picture whose dwell time is no longer than the predetermined time threshold is found. In this step, physical information of the picture whose dwell time is no longer than the predetermined time threshold may be extracted.

At sub-step S1046′, physical information of the picture currently being displayed on the display screen is extracted.

In this sub-step, the physical information of the picture currently being displayed on the display screen may be directly extracted in the case where the dwell time of the picture currently being displayed on the display screen is no longer than the predetermined time threshold.

In an application scenario where a random number operation interface needs to be opened for random password input, the random number operation interface is usually not a randomized interface. If a random password is generated based on the picture displayed on the random number operation interface, the random password may not be very secure. In this case, the physical information of the picture displayed on the last frame of the non-random number operation interface before switching to the random number operation interface may be extracted.

As used herein, the term “random number operation interface” may refer to an interface displayed on a display screen for generating, displaying, or logging in a random number or a random password. The term “non-random number operation interface” may refer to an interface other than the random number operation interface of the display screen on which interface a picture may be normally displayed.

FIG. 7 schematically illustrates a flowchart of a method for generating a random number in another embodiment of the present disclosure. The flowchart shown in FIG. 7 shares some similarities with the flowchart shown in FIG. 3, and the description provided with respect to FIG. 3 applies to the flowchart shown in FIG. 7 as appropriate.

As shown in FIG. 7, the method for generating a random number may include the steps S102, S104″, S106, and S108 as described in detail below. In the embodiment shown in FIG. 7, steps S102, S106, and S108 are the same as in the embodiment shown in FIG. 3, and thus the detailed description of steps S102, S106, and S108 in FIG. 3 applies equally to the flowchart in FIG. 7. Here, only the step S104″, i.e., the step of extracting the physical information of the picture displayed on the display screen, which is different from the embodiment shown in FIG. 3, is described in detail.

As shown in FIG. 7, the physical information of the picture displayed on the display screen may be extracted by the sub-steps S1042″, S1044″ and S1046″ as described in detail below.

At sub-step S1042″, it is detected whether the display screen is in the random number operation interface when the random number generation instruction is received. In the case where it is detected that the display screen is in the random number operation interface, sub-step S1044″ is performed. In the case where it is detected the display screen is in a non-random number operation interface, sub-step S1046″ is performed.

At sub-step S1044″, physical information of a picture displayed in the last frame of the non-random number operation interface before the display screen is switched to the random number operation interface is extracted.

In this sub-step, in the case where the display screen is in the random number operation interface, the random number operation interface is usually not a random interface, and thus the security may not be high. In order to improve the security, the physical information of the picture displayed in the last frame of the non-random number operation interface before the random number operation interface may be extracted.

At sub-step S1046″, physical information of the picture currently being displayed on the display screen is extracted.

In this sub-step, in the case where it is detected that the display screen is in the non-random number operation interface, i.e., the display screen is in the interface where the display screen normally displays pictures, the randomness of the display screen displaying the pictures is relatively high, and thus the physical information of the picture being currently displayed on the display screen may be directly extracted in order to generate the random number based on the physical information.

As already described above, an m×n matrix may be generated as a random number matrix based on the physical information of the m×n pixels 401 of the display screen, wherein the physical information of the m×n pixels 401 serves as matrix elements of the random matrix. Generally, the matrix including the pixels 401 of the display screen is a rectangular matrix, i.e., m is not equal to n. Therefore, the resulting random matrix is also a rectangular matrix.

In general, a square-order matrix typically has richer eigenvalues. As an example, the eigenvalue of the square-order matrix may be represented by a trace or a norm of the square-order matrix, e.g., 1-norm of the matrix or 2-norm of the matrix, in addition to a sum, a sum of squares, a square root of a sum of squares, a sum of square roots, a square of a sum of all matrix elements as already described above.

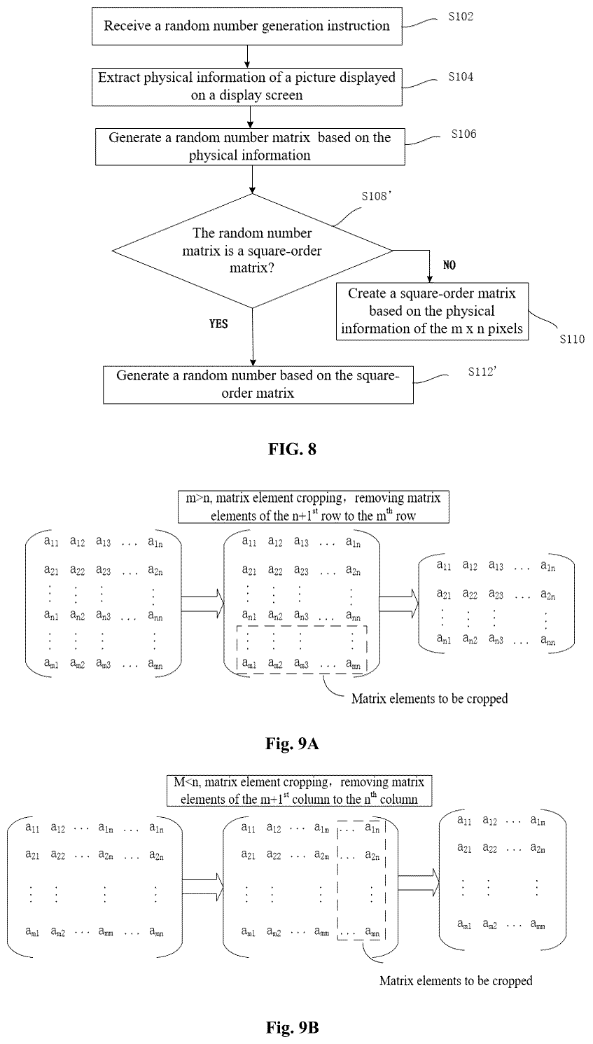

In one or more embodiments of the present disclosure, the random number may be generated based on the square-order matrix. FIG. 8 schematically illustrates a flowchart of a method for generating a random number according to still another embodiment of the present disclosure. The flowchart shown in FIG. 8 shares some similarities with the flowchart shown in FIG. 3, and the description provided with respect to FIG. 3 applies to the flowchart shown in FIG. 8 as appropriate.

As shown in FIG. 8, the method for generating a random number includes steps S108′, S110′, and S112′ that are different from the flowchart shown in FIG. 3, in addition to steps S102, S104, and S106 in the flowchart shown in FIG. 3.

With respect to the steps S102, S104, S106 in the flowchart shown in FIG. 8, reference may be made to the detailed description with respect to the flowchart shown in FIG. 3, as appropriate. The following describes in detail where the embodiment shown in FIG. 8 differs from the embodiment shown in FIG. 3.

As shown in FIG. 8, after the random number matrix is generated at step S106, it may be detected whether the random number matrix is a square-order matrix at step S108′. In the case that the generated random number matrix is not a square-order matrix, a square-order matrix may be created at step S110′ based on the physical information of the m×n pixels 401.

In some embodiments of the present disclosure, the square-order matrix may be created by performing matrix element cropping or matrix element addition to the m×n matrix formed from the physical information of the m×n pixels 401.

### Matrix Element Cropping

$$m > n \qquad i )$$

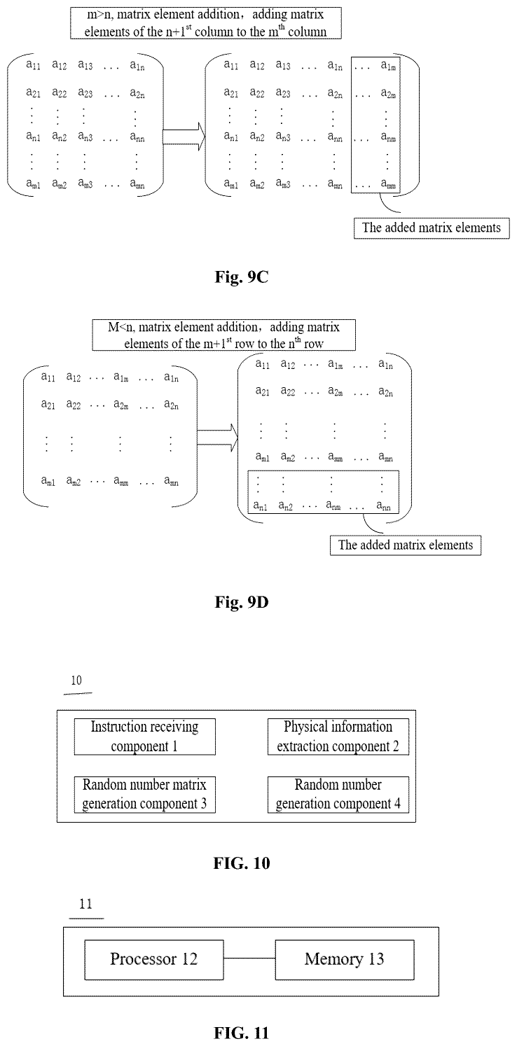

FIG. 9A illustrates a schematic diagram of creating a square-order matrix by matrix element cropping in the case where m>n in some embodiments of the present disclosure. As shown in FIG. 9A, in the case where m>n, an n×n square-order matrix may be formed by removing matrix elements of the n+1st row to the mth row of the m×n matrix. By way of example, for a 120×100 matrix, a 100×100 square-order matrix may be formed by removing the matrix elements of row 101 to row 120 of the 120×100 matrix.

In an alternative embodiment, the n×n square-order matrix may be formed by removing matrix elements of any m-n rows of the m×n matrix. By way of example, the matrix elements of any 20 rows of the 120×100 matrix may be removed without being limited to the matrix elements of the last 20 rows of the 120×100 matrix.

m<n ii)

FIG. 9B illustrates a schematic diagram of creating a square-order matrix by matrix element cropping in the case where m<n in some embodiments of the present disclosure. As shown in FIG. 9B, in the case where m<n, an m×m square-order matrix may be formed by removing matrix elements of the m+1st to the nth column of the m×n matrix. By way of example, for a 100×120 matrix, a 100×100 square-order matrix may be formed by removing the matrix elements of column 101 to column 120 of the 100×120 matrix.

In an alternative embodiment, the m×m square-order matrix may be formed by removing matrix elements of any n-m columns of the m×n matrix. By way of example, the matrix elements of any 20 columns of the 100×120 matrix may be removed without being limited to the matrix elements of the last 20 columns of the 100×120 matrix.

### Matrix Element Addition

m>n i)

FIG. 9C illustrates a schematic diagram of creating a square-order matrix by matrix element addition in the case where m>n in some embodiments of the present disclosure. As shown in FIG. 9C, in the case where m>n, an m×m square-order matrix may be formed by inserting m-n column matrix elements into the m×n matrix. In some embodiments, a value of each inserted matrix element may be calculated based on a mean of values of the known elements in the row where the inserted matrix element is located.

For example, for a 5×3 matrix, matrix elements of columns 4 to 5 may be inserted into the 5×3 matrix to form a 5×5 square-order matrix.

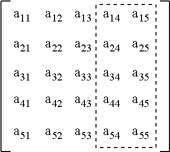

The value of each inserted matrix element may be calculated based on a mean of values of the known matrix elements in the row where the matrix element is located, i.e.,

a₁₄=(a₁₁+a₁₂+a₁₃)/3, a₁₅=(a₁₁+a₁₂+a₁₃+a₁₄)/4.

Similarly, a₂₄=(a₂₁+a₂₂+a₂₃)/3, a₂₅=(a₂₁+a₂₂+a₂₃+a₂₄)/4;

a₅₄=(a₅₁+a₅₂+a₅₃)/3, a₅₅=(a₅₁+a₅₂+a₅₃+a₅₄)/4.

In an alternative embodiment, the value of each inserted matrix element may be calculated by dividing a root mean square or a square root of a sum of squares of the known elements in the row where the inserted matrix element is located by the number of the known elements in the row.

In an alternative embodiment, m-n columns of matrix elements may be randomly inserted into the m×n matrix to form an m×m square-order matrix. By way of example, 2 columns of matrix elements may be randomly inserted into the 5×3 matrix without being limited to inserting matrix elements in columns 4 to 5 behind column 3 of the 5×3 matrix. By way of example, two columns of matrix elements may be inserted between the first and second columns and between the second and third columns of the 5×3 matrix, respectively. The value of each inserted matrix element may likewise be calculated based on the mean of values of the known elements in the row where the inserted matrix element is located, or by dividing a root mean square or a square root of a sum of squares of the known elements in the row where the inserted matrix element is located by the number of the known elements in the row.

m<n ii)

FIG. 9D illustrates a schematic diagram of creating a square-order matrix by matrix element addition in the case where m<n in some embodiments of the present disclosure. As shown in FIG. 9D, in the case where m<n, an n×n square-order matrix may be formed by inserting m-n rows of matrix elements into the m×n matrix. In some embodiments, a value of each inserted matrix element may be calculated by averaging the values of the known elements in the column where the inserted matrix element is located.

For example, for a 3×5 matrix, matrix elements of rows 4 to 5 may be inserted into the 3×5 matrix to form a 5×5 square-order matrix.

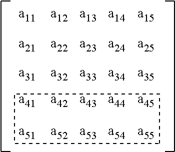

A value of each inserted matrix element may be calculated based on the mean of values of known matrix elements in the column where the matrix element is located, i.e.,

a₄₁=(a₁₁+a₂₁+a₃₁)/3, a₅₁=(a₁₁+a₂₁+a₃₁+a₄₁)/4.

Similarly, a₄₂=(a₁₂+a₂₂+a₃₂)/3, a₅₂=(a₁₂+a₂₂+a₃₂+a₄₂)/4;

A₄₅=(a₁₅+a₂₅+a₃₅)/3, a₅₅=(a₁₅+a₂₅+a₃₅+a₄₅)/4.

In an alternative embodiment, the value of each inserted matrix element may be calculated by dividing a root mean square or a square root of a sum of squares of the known elements in the column where the inserted matrix element is located by the number of the known elements in the column.

In an alternative embodiment, n-m rows of matrix elements may be randomly inserted into the m×n matrix to form an n×n square-order matrix. By way of example, 2 rows of matrix elements may be randomly inserted into the 3×5 matrix without being limited to inserting matrix elements in rows 4 to 5 behind row 3 of the 3×5 matrix. By way of example, two rows of matrix elements may be inserted between the first and second rows and between the second and third rows of the 3×5 matrix, respectively. The value of the matrix element may likewise be calculated based on the mean of values of the known elements in the row where the inserted matrix element is located, or by dividing a root mean square, or a square root of a sum of squares of the other known elements in the column where the inserted matrix element is located by the number of known elements in the column.

Returning to FIG. 8, at step S112′, a random number is generated based on the square-order matrix. Details regarding generating the random number based on the square-order matrix may be referred to the process of generating the random number based on the random number matrix described in detail with respect to the embodiment shown in FIG. 3 as appropriate. Unlike the generation of the random number based on the random number matrix in the embodiment shown in FIG. 3, in the embodiment shown in FIG. 8, the eigenvalue of the square-order matrix may be calculated based on a trace or a norm of the square-order matrix in addition to the sum, the sum of squares, the square root of the sum of the squares, the sum of the square roots, and the square of the sum of all matrix elements.

In order to realize the method for generating a random number in the above embodiments, the present disclosure also provides an apparatus for generating a random number.

FIG. 10 is a block diagram of a device for generating a random number in one or more embodiments of the present disclosure. The device 10 as shown in FIG. 10 may be used to perform the method of generating a random number in the embodiments shown in FIG. 3, FIG. 6, FIG. 7, or FIG. 8. Thus, the description provided with respect to FIG. 3, FIG. 6, FIG. 7, or FIG. 8 applies to the device shown in FIG. 10 as appropriate. As shown in FIG. 10, the device may include an instruction receiving component 1, a physical information extraction component 2, a random number matrix generation component 3, and a random number generation component 4.

The instruction receiving component 1 is configured to receive a random number generation instruction. A user may issue the random number generation instruction through an input/output interface of the smart terminal.

The physical information extraction component 2 is configured to extract physical information of a picture displayed on a display screen.

The physical information of the displayed picture may include physical information of the pixels 401 of the displayed picture, such as, grayscale, brightness, voltage, and color attributes of the pixels 401. In one or more embodiments, the physical information extraction component 2 may be specifically configured to extract the physical information of the picture currently being displayed on the display screen when the random number generation instruction is received.

The random number matrix generation component 3 is configured to generate a random number matrix based on the physical information.

In one or more embodiments, the display screen may include m×n pixels 401 arranged in an array, where m and n are positive integers. In the case, the random number matrix may include an m×n matrix. In the embodiment, the physical information of the m×n pixels 401 may be determined as matrix elements of the m×n matrix.

In some embodiments, the random number matrix may include a square-order matrix. In these embodiments, the random number generation component may be configured to create the square-order matrix based on the physical information of the m×n pixels 401 in one of the following ways:
a) performing matrix element cropping on the m×n matrix formed from the physical information of the m×n pixels 401; or
b) performing matrix element addition to the m×n matrix formed from the physical information of the m×n pixels 401.

For details of matrix element cropping and matrix element addition, reference may be made to the detailed description of matrix element cropping and matrix element addition in one or more embodiments relating to the method for generating the random number above.

The random number generation component 4 is configured to generate the random number based on the random number matrix. For details of the random number generation component generating the random number based on the random number matrix, reference may be made to the detailed description of generating the random number based on the random number matrix in the one or more embodiments relating to the method for generating the random number above.

In a further aspect of the present disclosure, another device for generating a random number is provided. FIG. 11 is a block diagram of another device for generating a random number in one or more embodiments of the present disclosure. As shown in FIG. 11, the device 11 may include at least one processor 12 and at least one memory 13, the memory 13 including computer program code which, when executed by the at least one processor 12, causes the device 11 to perform the steps of the method in one or more embodiments of the present disclosure involving a method for generating a random number. Accordingly, the description provided herein with respect to the method for generating a random number applies to the device shown in FIG. 11 as appropriate.

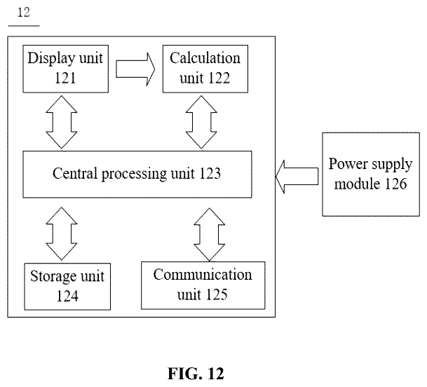

In a further aspect of the present disclosure, an apparatus for generating a random number is also provided. FIG. 12 is a schematic diagram of an apparatus for generating a random number in one or more embodiments of the present disclosure. As shown in FIG. 12, the apparatus 12 for generating a random number may include: a display unit 121, a calculation unit 122, a central processing unit 123, a storage unit 124, a communication unit 125, and a power supply module 126. The power supply module 126 is used to supply power to various units or modules of the apparatus. The display unit 121 is used to display a picture and optionally receive a random number generation instruction. The display unit 121 may include a display module, a driver module and optionally a touch module. The storage unit 124 is used to store executable program code and physical information (e.g., gray scale, voltage, brightness, color attribute of pixels, etc.) of the picture displayed on the display unit 121. The calculation unit 122 runs the executable program by reading the physical information of the displayed picture and the executable program stored in the storage unit for: generating a random number matrix based on the physical information of the picture displayed by the display unit and generating a random number based on the random number matrix. The central processing unit 123 is used to receive requests from the respective functional modules and send instructions to the respective functional unit or module. The communication unit 125 is used for the apparatus to communicate with the outside world to obtain or send information.

As is apparent from the discussion herein, it should be recognized that throughout this specification, unless otherwise specified, the use of terms such as “operating”, “calculating”, “generating” or the like, refers to the action and/or process of a computer or computing system or similar electronic computing device that manipulates and/or converts data that is represented as a physical (e.g., electronic) quantity in the registers and/or memories of the computing system into other data that is similarly represented as a physical quantity in the memories, registers, or other such information storage, transmission, or display devices of the computing system.

Embodiments of the present disclosure may include an apparatus for performing the operations described herein. This apparatus may be specially constructed for the desired purpose, or this apparatus may include a general-purpose computer or field programmable gate array (“FPGA”) or a digital signal processor (“DSP”) that is selectively activated or reconfigured by a computer program stored in the computer. Such computer programs may be stored in computer readable storage media such as, but not limited to, any type of diskette, including floppy disks, optical disks, CD-ROMs, magnetic disks, read-only memories (ROMs), random access memories (RAMs), electrically programmable read-only memories (EPROMs), electrically erasable programmable read-only memories (EEPROMs), magnetic or optical cards, or any other type of medium suitable for storing electronic instructions and capable of being coupled to a computer system bus.

The methods presented herein are not inherently associated with any specific computer or other apparatus. Various general-purpose systems may be used in conjunction with programs based on the teachings herein, or they may prove convenient for constructing more specialized devices to perform the desired methods. The desired configuration of various such systems will be clear from the above description. In addition, embodiments of the present disclosure are not described with reference to any specific programming language. It will be recognized that various programming languages may be used to implement the teachings of the present disclosure as described herein.

The foregoing description of the embodiment has been provided for purpose of illustration and description. It is not intended to be exhaustive or to limit the application. Individual elements or features of a particular embodiment are generally not limited to that particular embodiment, but, where applicable, are interchangeable and may be used in a selected embodiment, even if not specifically shown or described. The same may also be varied in many ways. Such variations are not to be regarded as a departure from the application, and all such modifications are included within the scope of the application.

1. A method for generating a random number comprising:
receiving a random number generation instruction;
extracting physical information of a picture displayed on a display screen, wherein the physical information of the displayed picture comprises one or more of grayscale, brightness, voltage, or color attribute of a pixel of the displayed picture;
generating a random number matrix based on the physical information; and
generating a random number based on the random number matrix.

2. The method according to claim 1, wherein extracting physical information of a picture displayed on a display screen comprises:
extracting the physical information of the picture being displayed on the display screen when the random number generation instruction is received.

3. The method according to claim 1, wherein extracting physical information of a picture displayed on a display screen comprises:
detecting whether dwell time of the picture displayed on the display screen when the random number generation instruction is received is longer than a predetermined time threshold; and
extracting, in response to a detection that the dwell time of the displayed picture is longer than the predetermined time threshold, physical information of another picture displayed prior to the picture currently being displayed on the display screen, wherein the dwell time of the another picture on the display screen is no longer than the predetermined time threshold, or
extracting, in response to a detection that the dwell time of the displayed picture is no longer than the predetermined time threshold, the physical information of the picture currently being displayed on the display screen.

4. (canceled)

5. The method according to claim 1, wherein extracting physical information of a picture displayed on a display screen comprises:
detecting whether the display screen is in a random number operation interface when the random number generation instruction is received; and
extracting, in response to a detection that the display screen is in the random number operating interface, physical information of a picture displayed in a last frame of a non-random number operating interface before the display screen is switched to the random number operating interface, or
extracting, in response to a detection that the display screen is in a non-random number operating interface, the physical information of the picture currently being displayed on the display screen.

6. The method according to claim 1, wherein the display screen comprises m×n pixels arranged in an array, where m and n are positive integers, wherein generating a random number matrix based on the physical information comprises:
determining matrix elements of the random number matrix based on the physical information of the m×n pixels.

7. The method according to claim 6, wherein the random number matrix comprises an m×n matrix whose matrix elements are determined based on the physical information of the m×n pixels.

8. The method according to claim 6, further comprising:
determining whether the random number matrix is a square-order matrix, and
creating, in response to a determination that the random number matrix is not a square-order matrix, the square-order matrix by performing matrix element cropping or matrix element addition to the m×n matrix formed from the physical information of the m×n pixels.

9. The method according to claim 8, wherein, in the case where m>n, matrix elements are cropped from the m×n matrix by removing m-n rows of matrix elements from the m×n matrix, to form an n×n square-order matrix, or
matrix elements are added to the m×n matrix by inserting m-n columns of matrix elements into the m×n matrix, to form an m×m square-order matrix, wherein a value of each inserted matrix elements is calculated based on values of known matrix elements in a row where the inserted matrix elements is located;
in the case where m<n, matrix elements are cropped from the m×n matrix by removing n-m columns of matrix elements from the m×n matrix, to form an m×m square-order matrix, or matrix elements are added to the m×n matrix by inserting n-m rows of matrix elements into the m×n matrix, to form an n×n square-order matrix, wherein the value of each inserted matrix elements is calculated based on values of known matrix elements in a columns in where the inserted matrix elements are is located.

10. The method according to claim 9, wherein, in the case where m>n, matrix elements of n+1^{st} to m^{th} rows of the m×n matrix is removed to form the n×n square order matrix, or
matrix elements of n+1^{st} to m^{th} columns are inserted into the m×n matrix to form the m×m square-order matrix, wherein the value of each inserted matrix element is calculated in one of the following ways:
an average of all known elements in the row where the inserted matrix element is located,
a root mean square of all known elements in the row where the inserted matrix element is located, or
a square root of a sum of squares of all known elements in the row where the inserted matrix element is located divided by the number of known elements in the row;
in the case where m<n, matrix elements of the m+1^{st} to n^{th} columns of the m×n matrix are removed to form the m×m square order matrix, or
matrix elements of the m+1^{st} to n^{th} rows are inserted into the m×n matrix to form the n×n square-order matrix, wherein the value of each inserted matrix element is calculated in one of the following ways:
an average of all known elements in the column where the inserted matrix element is located, the
a root mean square of all known elements in the column where the inserted matrix element is located, or
a square root of a sum of squares of all known elements in the column where the inserted matrix element is located divided by the number of known elements in the column.

11. The method according to claim 6, wherein generating a random number based on the random number matrix comprises:
calculating an eigenvalue of the random number matrix based on the matrix elements of the random number matrix;
performing a rounding operation on the calculated eigenvalue;
determining whether a digit number of the rounded eigenvalue is an odd number or an even number; and
selecting, in response to a determination that the digit number of the rounded eigenvalue is an even number, an even number of digits between the leftmost digit and the rightmost digit of the rounded eigenvalue as the random number; or
selecting, in response to a determination that the digit number of the rounded eigenvalue is an odd number, an odd number of digits between the leftmost digit and the rightmost digit of the rounded eigenvalue as the random number.

12. The method according to claim 11, wherein generating a random number based on the random number matrix further comprises:
determining whether the digit number of the rounded eigenvalue is less than a predetermined digit number threshold; and
in response to a determination that the digit number of the rounded eigenvalue is less than the predetermined digit number threshold:
performing at least one secondary operation on the rounded eigenvalue until the digit number of the eigenvalue obtained after the secondary operation is not less than the predetermined digit number threshold,
determining whether the digit number of the eigenvalue obtained after the secondary operation is an odd number or an even number, and
in response to a determination that the digit number of the eigenvalue obtained after the secondary operation is an even number, selecting an even number of digits between the leftmost digit and the rightmost digit of the eigenvalue obtained after the secondary operation as the random number, or
in response to a determination that the digit number of the eigenvalue obtained after the secondary operation is an odd number, selecting an odd number of digits between the leftmost digit and the rightmost digit of the eigenvalue obtained after the secondary operation as the random number, and
wherein the step of determining whether the digit number of the rounded eigenvalue is an odd number or an even number is performed in the case of the determination that the digit number of the rounded eigenvalue is not less than the predetermined digit number threshold.

13. The method according to claim 12, wherein performing at least one secondary operation on the rounded eigenvalue comprises performing at least one N-square operation or multiplicative operation on the rounded eigenvalue, where N≥2.

14. The method according to claim 11, wherein the eigenvalue of the random number matrix is calculated in one of the following ways:
determining a sum of all matrix elements of the random number matrix;
determining a sum of squares of all matrix elements of the random number matrix;
determining a square root of a sum of squares of all matrix elements of the random number matrix;
determining a sum of square roots of all matrix elements of the random number matrix; or
determining a square of a sum of all matrix elements of the random number matrix,
in the case where the random number matrix comprises a square-order matrix, the eigenvalue of the random number matrix is further calculated by determining a trace or a norm of the square-order matrix.

15. (canceled)

16. An device for generating a random number comprising:
an instruction receiving component configured to receive a random number generation instruction;
a physical information extraction component configured to extract physical information of a picture displayed on a display screen, wherein the physical information of the displayed picture comprises one or more of grayscale, brightness, voltage, or color attribute of a pixel of the displayed picture;
a random number matrix generation component configured to generate a random number matrix based on the physical information; and
a random number generation component configured to generate a random number based on the random number matrix.

17. The device according to claim 16, wherein the physical information extraction component is configured to extract the physical information of the picture currently being displayed on the display screen when the random number generation instruction is received.

18. The device according to claim 16, wherein the display screen comprises m×n pixels arranged in an array, wherein m and n are positive integers, wherein the random number matrix comprises an m×n matrix, and wherein matrix elements of the m×n matrix are determined based on the physical information of the m×n pixels.

19. (canceled)

20. The device according to claim 18, wherein the random number matrix comprises a square-order matrix, and wherein the random matrix generation component is configured to create the square-order matrix by performing matrix element cropping or matrix element addition to the m×n matrix formed from the physical information of the m×n pixels.

21. The device according to claim 1918, wherein the random number generation component is configured to:
calculate an eigenvalue of the random number matrix based on the matrix elements of the random number matrix;
perform a rounding operation on the calculated eigenvalue;
determine whether a digit number of the rounded eigenvalue is an odd number or an even number; and
select, in response to a determination that the digit number of the rounded eigenvalue is an even number, an even number of digits between the leftmost digit and the rightmost digit of the rounded eigenvalue as the random number; or
select, in response to a determination that the digit number of the rounded eigenvalue is an odd number, an odd number of digits between the leftmost digit and the rightmost digit of the rounded eigenvalue as the random number.

22. The device according to claim 21, wherein the random number generation component is configured to calculates the eigenvalue of the random number matrix in one of the following ways:
determining a sum of all matrix elements of the random number matrix;
determining a sum of squares of all matrix elements of the random number matrix;
determining a square root of a sum of squares of all matrix elements of the random number matrix;
determining a sum of square roots of all matrix elements of the random number matrix; or
determining a square of a sum of all matrix elements of the random number matrix,
in the case where the random number matrix comprises a square-order matrix, the random number generation component is further configured to calculate the eigenvalue of the random number matrix by determining a trace or a norm of the square order matrix.

23. (canceled)

24. An device for generating a random number, comprising:
at least one processor; and
at least one memory comprising computer program code, which, when executed by the at least one processor, causes the device to perform the method claimed in claim 1.
